(19) United States
(12) Patent Application Publication
(10) Pub. No.: US 2020/0175624 A1
(43) Pub. Date: Jun. 4, 2020

(54) SCOPE OF WORK GENERATOR FOR WORKING REAL PROPERTY

(71) Applicant: PACIFY TECHNOLOGIES, LLC, Boston, MA (US)

(72) Inventors: Freddy Nole BAFUKA, Brighton, MA (US); Bobin John CHERIAKALATH, Medford, MA (US)

(21) Appl. No.: 16/699,291

(22) Filed: Nov. 29, 2019

Related U.S. Application Data
(60) Provisional application No. 62/773,525, filed on Nov. 30, 2018.

(51) Int. Cl. G06Q 50/16; G06Q 30/02; G06Q 30/06

(52) U.S. Cl. CPC G06Q 50/165; G06Q 30/0641; G06Q 30/0283

(57) ABSTRACT

An example non-transitory machine-readable storage medium includes instructions to analyze a unit of real property to facilitate generation of a scope of work for working the unit of real property. When executed, the instructions cause a processor of a computing device to obtain real property data describing the unit of real property, identify a workable feature of the unit of real property based on the real property data, determine a quantitative factor describing the workable feature, and provide an indication of the workable feature and the quantitative factor to another computer device. A consumer user interface and a provider user interface are described.

### BACKGROUND

Information technology may be used to coordinate the provision of goods and services direct to consumers. For example, software platforms are routinely used by consumers to search for potential providers, and by providers to advertise goods or services to potential consumers. When a consumer is interested in hiring or purchasing from a provider, a software platform may provide a means of communicating or transacting between the consumer and the provider so that a mutually agreeable transaction may be performed.

Where the goods or services relate to real property, such as, for example, home maintenance work, lawn mowing, snow shovelling, fence installation, solar panel installation, and the like, a provider typically conducts a consultation with the potential consumer at the real property. When present at the real property, the provider is able to assess the scale of the work requested by the potential consumer and negotiate mutual agreeable terms of service with the potential consumer. The need for a provider to visit real property to assess the scale of work increases transaction costs.

### SUMMARY

According to an aspect of the specification, an example non-transitory machine-readable storage medium comprising instructions that when executed cause a processor of a computing device to prepare a unit of real property for the automated generation of a scope of work for working the unit of real property is provided. The instructions cause the processor to obtain real property data describing a unit of real property, identify a workable feature of the unit of real property based on the real property data, determine a quantitative factor describing the workable feature, and transmit an indication of the workable feature and the quantitative factor to another computer device.

According to another aspect of the specification, an example non-transitory machine-readable storage medium comprising instructions that when executed cause a processor of a computing device to generate a scope of work for working a unit of real property is provided. The instructions cause the processor to receive an indication of a workable feature of a unit of real property and a quantitative factor describing the workable feature and generate a user interface. The user interface includes a real property display component including a visual representation of the unit of real property and a visual representation of the workable feature, a task selection component including a task button indicating a particular task to work the workable feature, and a cost calculator component to display a cost to complete a scope of work involving one or more tasks to be performed on one or more workable features of the unit of real property. The instructions further cause the processor to, upon detecting selection of the task button, increment the cost of completing the scope of work by a cost of performing the particular task to work the workable feature.

According to yet another aspect of the specification, an example system for generating a scope of work for working real property is provided. The system includes a real property analyzer to obtain real property data describing a unit of real property, identify a workable feature of the unit of real property based on the real property data, and determine a quantitative factor describing the workable feature. The system further includes a consumer computing device to receive an indication of the workable feature of the unit of real property and the quantitative factor describing the workable feature, and generate a scope of work to perform one or more tasks on one or more workable features of the unit of real property. The system further includes a provider computing device to receive the scope of work, display a location of the unit of real property where the scope of work is to be performed, display a list of one or more tasks to be completed pursuant to the scope of work, and display visual representations of one or more workable features of the unit of real property on which the one or more tasks are to be performed.

### BRIEF DESCRIPTION OF THE DRAWINGS

FIG. 1 is a schematic diagram of an example system for generating a scope of work for working real property.

FIG. 2 is a schematic diagram of an example consumer user interface showing options to select tasks to work workable features of a unit of real property to be included in a scope of work.

FIG. 3 is a schematic diagram of an example consumer user interface showing a task to work a workable feature of the unit of real property having been selected.

FIG. 4 is a schematic diagram of an example consumer user interface showing the selection of workable features of a unit of real property using a grid component.

FIG. 5 is a schematic diagram of an example provider user interface for viewing a scope of work.

FIG. 6 is a flowchart of an example method for preparing a unit of real property for the automated generation of a scope of work for working the unit of real property.

FIG. 7 is a flowchart of an example method for generating a scope of work for working a unit of real property.

FIG. 8 is a flowchart of an example method for displaying a scope of work for working real property.

### DETAILED DESCRIPTION

A consumer of goods or services relating to a unit of real property may generate a scope-of-work request for a provider based on the automated analysis of workable features of the unit of real property. The scope-of-work may be generated through a customer user interface by selecting tasks to work workable features of the property. The workable features of the property may have been identified by an automated system based on real estate data.

For example, a homeowner wishing to have work done on the property, such as the shovelling of snow, the cutting of grass, the installation of a fence, or the installation of solar panels, may generate a scope-of-work request for a provider to have the requested work done. The scope-of-work may be generated through a customer user interface by selecting tasks to work workable features of the property, such as sidewalks which may be shovelled, sections of lawns which may be mowed, or sections of roofing on which solar panels may be installed. The workable features of the property may have been identified by an automated system based on real estate data, such as data from government land registries, private data stores, and imagery such as aerial image data.

Once a scope-of-work request is generated, the provider of goods or services may receive the scope-of-work request and refer to the scope-of-work request when fulfilling the scope-of-work. Transaction costs associated with the provider visiting the real property may thereby be attenuated.

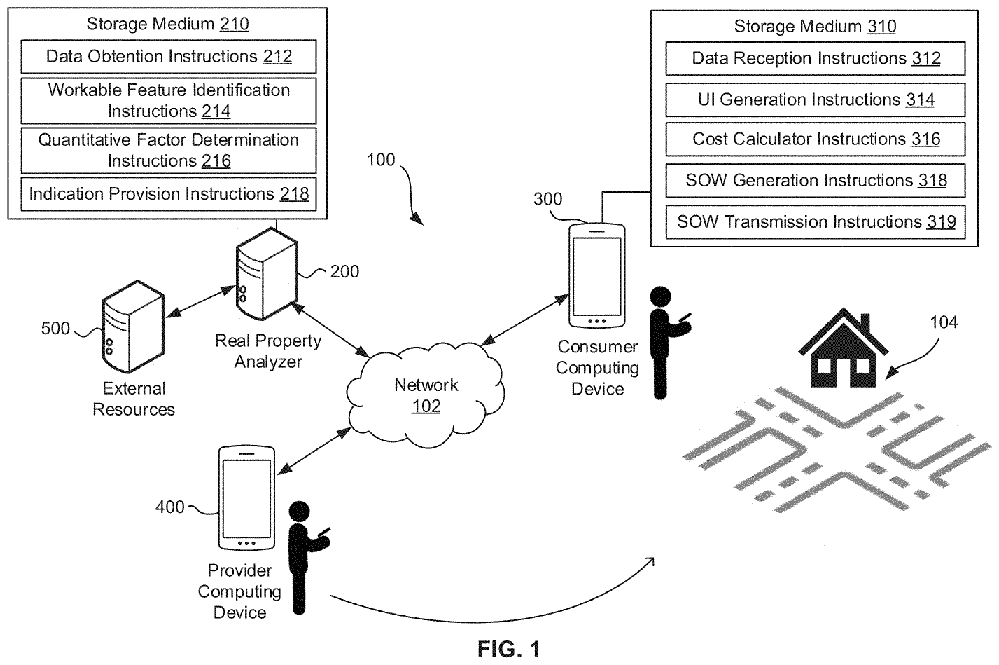

FIG. 1 is a schematic diagram of an example system 100 for generating a scope of work for working real property. The system 100 includes a consumer computing device 300, a real property analyzer 200, and a provider computing device 400 in communication via one or more computing networks 102.

The real property analyzer 200 may include a computing device such as a server or other computing device having processing, communication, and memory means. The real property analyzer 200 includes a non-transitory machine-readable storage medium 210 which includes data obtention instructions 212, workable feature identification instructions 214, quantitative factor determination instructions 216, and indication provision instructions 218.

Thus, the non-transitory machine-readable storage medium 210 includes instructions that, when executed, cause a processor of the real property analyzer 200 to obtain real property data describing a unit of real property 104 (via data obtention instructions 212), identify a workable feature of the unit of real property 104 based on the real property data (via workable feature identification instructions 214), determine a quantitative factor describing the workable feature (via quantitative factor determination instructions 216), and transmit an indication of the workable feature and the quantitative factor to another computer device (via indication provision instructions 218).

Real property data may include any information relating to the unit of real property 104 which may be relevant to developing a scope of work for working workable features of the unit of real property 104. Real property data may be obtained through external resources 500, which may include other computing systems or data stores. Obtaining real property data describing the unit of real property may involve obtaining government or provide real estate data such as land title registry data, parcel information, footprint data, or other information relating to the boundaries of the property, the structures on the property, or other features of the property which may be relevant to identifying workable features of the unit of real property 104, from such external resources 500. Obtaining real property data describing the unit of real property 104 may also involve obtaining imagery data such as aerial imagery data of the unit of real property 104 from such external resources 500. Thus, external resources 500 may include one or more computer systems and/or data stores for real estate data describing the unit of real property, land title registry data describing the unit of real property, physical dimensions of a parcel of land of the unit of real property, and aerial imagery data of the unit of real property, or any other data which may be relevant to developing a scope of work for working workable features of the unit of real property 104.

A workable feature of the unit of real property 104 may include any feature of the property on which a service or good may be provided, such as a roof on which a solar panel may be provided, or a sidewalk which may be shoveled. Workable features of the unit of real property 104 may be identified by analysis of the real property data. For example, workable features may be identified by analyzing semantic information about the unit of real property 104, such as the size of the parcel of land of the unit of real property 104, the footprints, size, and/or location of structures on the property, which is stored, such as in government or private real estate data. As another example, workable features may be identified by analyzing visual information about the property, such as aerial images of the unit of real property 104, on which feature recognition algorithms, image recognition algorithms, land cover classification algorithms, or other techniques may be applied to identify workable features of the unit of real property 104. Combinations of the above techniques are contemplated. For example, the detection of a walkway on the property may involve a combination of analysis of aerial imagery, infrared imagery, LiDAR imagery, a building's footprint, and the parcel boundaries.

As discussed above, a quantitative factor describing the workable feature is to be determined. Such a quantitative factor may include any quanta which may be relevant to assessing the scope of work related to working the workable feature, such as the size of the workable feature. A quantitative factor describing a workable feature may be determined by further analysis of real property data, including semantic information and visual information about the unit of real property 104. For example, the surface area (or other physical dimension) of a driveway or the elevation change of a sidewalk may be recorded in a real estate listing, or may be determined based on visual analysis of aerial images. Thus, the quantitative factor of the workable feature of the unit of real property 104 may include a physical dimension of the workable feature.

The consumer computing device 300 may include a mobile computing device such as a smart phone or other computing device having processing, communication, and memory means. The consumer computing device 300 includes a non-transitory machine-readable storage medium 310 which includes data reception instructions 312, user interface generation instructions 314, and cost calculator instructions 316. Such instructions may be instantiated in a software application for installation at the consumer computing device 300.

Thus, the non-transitory machine-readable storage medium 310 includes instructions that when executed cause a processor of the consumer computing device 300 to receive an indication of a workable feature of the unit of real property 104 and a quantitative factor associated with the workable feature (via data reception instructions 312). The indications may be received from the real property analyzer 200. Thus, a consumer user interface running on the consumer computing device 300 may include information about the workable features of the unit of real property 104, such as, for example, the number and size of sidewalks, the number and size of portions of lawn, or the number and size of roofs.

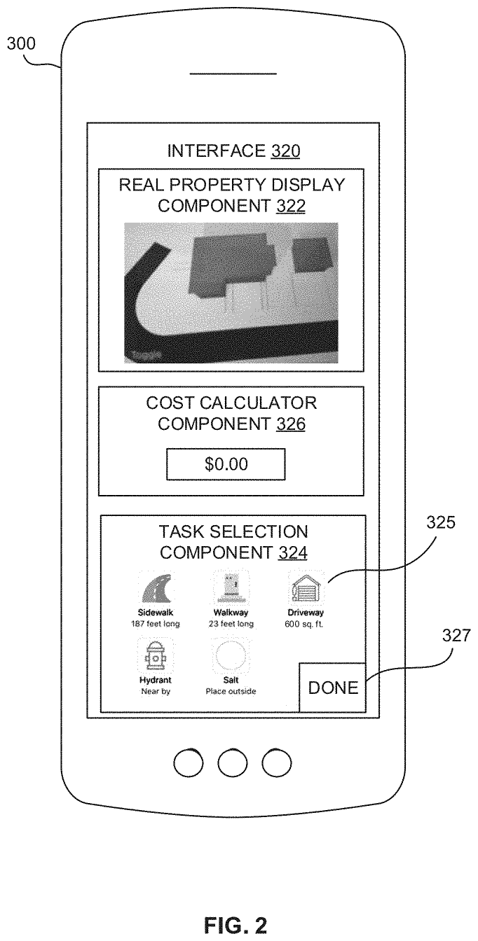

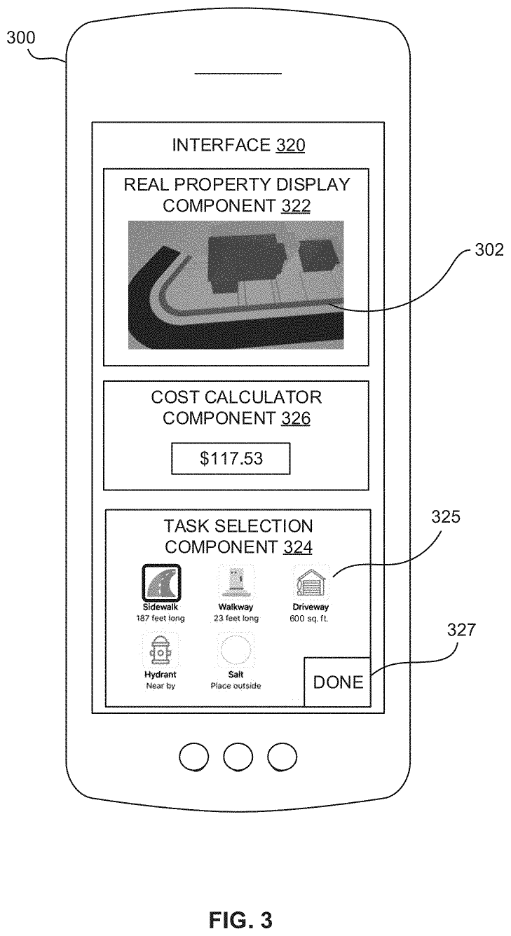

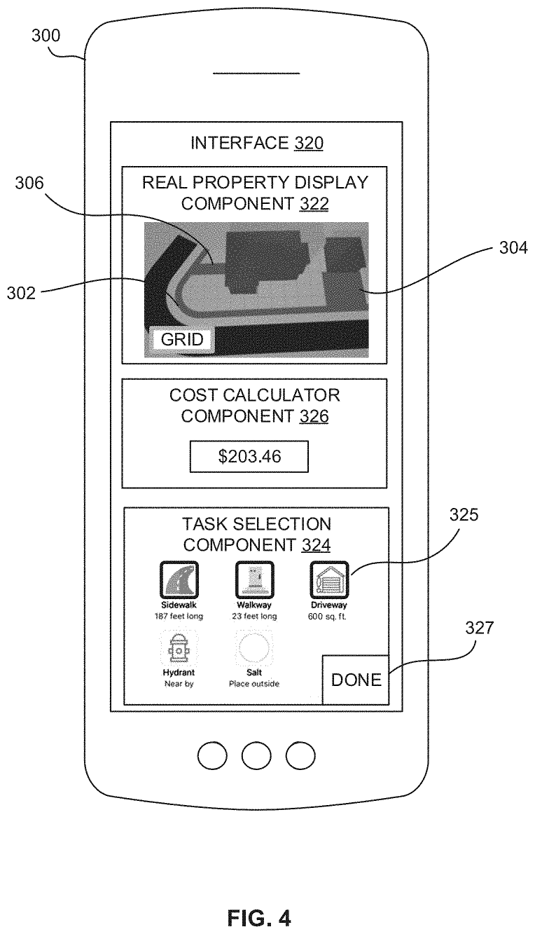

The storage medium 310 further includes instructions to generate a user interface having a real property display component (via the user interface generation instructions 314), the real property display component including a visual display of the unit of real property 104 and the workable feature, a task selection component including a task button indicating a particular task to work the workable feature, and a cost calculator component to display a cost to complete a scope of work involving one or more tasks to be performed on workable features of the unit of real property. An example of the consumer user interface is provided in FIG. 2. The storage medium 310 further includes instructions to, upon detecting selection of the task button, increment the cost of completing the scope of work by a cost of performing the particular task to work the workable feature (via cost calculator instructions 316). The incrementation of costs may be based on costing information provided by a service provider capable of performing the selected task, which may be provided using the provider computing device 400. Such costing information may be obtained by the software application that executes the instructions 316 for one or more of such provider computing devices 400. An example of the cost being incremented is provided in FIG. 3 and FIG. 4. The storage medium 310 may further include scope of work generation (SOW) instructions 318 to generate a scope of work indicating one or more particular tasks to be performed on one or more workable features of the unit of real property 104. The scope of work may be generated in an electronic document, printable document, image, email, text description, or other form of describing a scope of work. The storage medium 310 may further include scope of work transmission instructions 319 to transmit the generated scope of work to a provider computing device 400. Thus, a user of the provider computing device 400 may review the scope of work and commence procedures to perform the scope of work at the unit of real property 104.

Thus, workable features of the unit of real property 104 are analyzed at the real property analyzer 200 to identify workable features (e.g. a driveway or lawn) at the unit of real property 104 and quantitative factors describing those workable features (e.g. the size of the driveway or lawn). Such analysis may be performed on a regular or periodic basis. When a consumer wishes to have a task performed on a workable feature of the unit of real property 104, the consumer may use the consumer computing device 300 which receives such information from the real property analyzer 200 for use in a software application which allows the consumer to select tasks to be performed on workable features of the unit of real property 104 and generates a costed scope of work based on such information. Such a scope of work may be transmitted to a provider computing device 400 to be reviewed and acted upon by a service provider.

FIG. 2 is a schematic diagram of an example consumer user interface 320 running on a consumer computing device 300. The consumer user interface 320 shows options to select tasks to work workable features of the unit of real property 104 to generate a scope of work for working the unit of real property 104.

The consumer user interface 320 includes a real property display component 322 that provides a visual display of the unit of real property 104 and one or more workable features of the unit of real property 104. As shown, the real property display component 322 includes a visual representation of the unit of real property 104, including a parcel of land, a residential structure on the land, a separate garage on the land, and a municipal road along an edge of the property. The real property display component 322 shows workable features on the property, including a sidewalk, a driveway, and three walkways to the residential structure. A visual depiction of the property may include a three-dimensional rendering of the property. The real property display component 322 may further display visual representations of lighting and/or shadow integrated with the property. The lighting and shadows may make the property more recognizable to the consumer, and may assist in determining the scope of work involving tasks which may be impacted by exposure to the sun, such as, for example, the placement of solar panels on a roof, which may be affected by sunlight coverage of the roof, or the maintenance of a lawn, which differ with respect to portions of the lawn which receive more or less sunlight.

The consumer user interface 320 further includes a task selection component 324 including one or more task buttons 325, each indicating with a particular task to work a workable feature. In the present example, the consumer user interface 320 relates to selecting tasks for shoveling snow on the real property, and thus the task selection component 324 includes task buttons 325 for shoveling the sidewalk, shoveling the walkways, shoveling the driveway, among other tasks. Thus, the task selection component 324 may include a plurality of task buttons 325 each associated with a respective task to work a different workable feature of the unit of real property 104. A task selection button 325 may be visually associated with an indication of a quantitative factor describing the task, such as the length of a sidewalk to be shoveled, the area of a driveway to be shoveled, or the area of a lawn to be mowed, or another physical dimension of the workable feature. In some examples, the entire workable feature may be selectable, such as an entire roof. In other examples, sub-elements of a workable feature may be selectable, such as different portions of a roof, or different segments of a sidewalk.

Further, in some examples, a task may be selected by interacting with the real property display component 322 itself. For example, in applications where a scope of work is to be generated for shoveling snow on a property, the consumer may touch the visual depiction of the sidewalk on the property to indicate that shoveling of the sidewalk is to be included in the scope of work. Selection of tasks by interacting with the real property display component 322 may be linked with selection of tasks by the selection of task buttons 325 in the task selection component 324. For example, a consumer may indicate that all walkways on the property are to be shoveled by pressing the appropriate task button 325, and then may deselect certain walkways from the selection by touching the appropriate visual depictions of the walkways to be deselected on the real property display component 322. In other words, a task button 325 may be overlain over the visual representation of the workable feature in the real property display component.

The consumer user interface 320 further includes a cost calculator component 326 to display a cost of completing a scope of work. As shown, no tasks have been selected to be added to the scope of work, and thus the estimated cost for completing the requested work is zero dollars. Upon selection of a task button 325, the cost of completing the scope of work by a cost of performing the task to work the workable feature is incremented, as shown in FIG. 3 and FIG. 4. Thus, upon selection of a particular task button 325 of the plurality of task buttons 325, the cost of completing the scope of work by a cost of performing the respective task may be incremented.

The consumer user interface may further include a button, such as a “complete”, “continue”, “send”, or “done” button 327 to generate or compile the scope of work for transmission to a provider computing device 400. A compiled scope of work may be transmitted directly to a provider computing device 400 for their action, or via the real property analyzer 200 for further processing.

FIG. 3 is a schematic diagram of an example consumer user interface 320 running on a consumer computing device 300, showing a task to work a workable feature of the unit of real property 104 selected. In particular, the task to shovel the sidewalk is selected, which increments the cost calculator component 326 to read the updated cost estimate. Further, the real property display component 322 may be updated to visually represent the selected task. In the present example, a visual representation 302 of the workable feature (e.g. an image of the sidewalk) is highlighted to indicate that a task to work the sidewalk has been selected (i.e. a task to shovel the sidewalk). Further, the visual representation 302 of the workable feature is thus embedded in, or overlaid upon, the visual representation of the unit of real property 104 to provide contextual understanding to the viewer for the workable feature, including any surrounding features which may impact the amount of work required to work the workable feature (e.g. trees, fences, or other obstructions within or near the workable feature, or an environmental factor such as lighting).

FIG. 4 is a schematic diagram of an example consumer user interface 320 running on a consumer computing device 300. Several visual representations 302, 304, 306, corresponding to workable features, which include the sidewalk, the driveway, and a walkway, respectively, are selected to be included in a scope of work. Further, the real property display component 322 shows a grid over the unit of real property 104 which allows selection of grid elements to select workable features of the unit of real property 104 which may not be listed in the task selection component 324 or to edit selections of tasks. For example, portions of a lawn to be mowed may be selected using grids. As another example, selection of shoveling the driveway in the task selection component 324 may be edited upon selection of grids of the driveway to indicate that only a portion of the driveway is to be shoveled. A user of the consumer user interface 320 may thus toggle the ability to select grids by pressing a grid toggle button. In some examples, the grid may be displayed on the property in a manner which is aligned to the largest building on the property. The real property display component 322 may further include a “grid” button to enable or disable display of such a grid over the unit of real property 104.

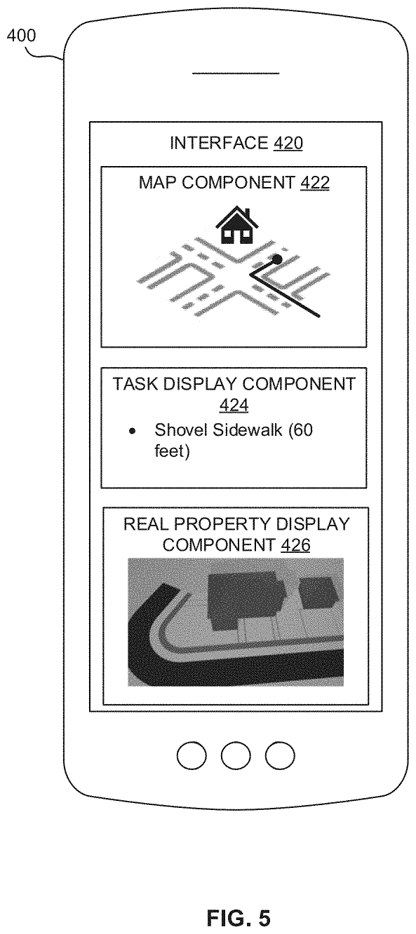

FIG. 5 is a schematic diagram of an example provider user interface 420 running on a provider computing device 400. The provider user interface 420 may be used to view a scope of work generated at the consumer computing device 300. The scope of work may be transmitted to the provider computing device 400 from the consumer computing device 300 or via the real property analyzer 200 or directly via the network 102.

The provider user interface 420 includes a map component 422 which displays a unit of real property 104, where the scope of work to be performed, is located on a map. The provider user interface 420 further includes a task display component 424 listing the tasks to be completed pursuant to the scope of work. The task display component 424 may further include an indication of a quantitative factor describing a task to be performed on a workable feature of the unit of real property 104 (e.g., the sidewalk to be shoveled is 60 feet in length). Further, the provider user interface further includes a real property display component 426 which visually displays the workable features of the unit of real property 104 on which work is to be conducted. The workable features on which tasks are to be performed, as listed in the task display component 424, may be highlighted or otherwise visually indicated in the real property display component 426.

In some examples, upon completion of a task or the scope of work, the provider may be prompted via the provider user interface 420 to capture an image of the completed work on the workable feature to provide evidence of the completed work. The captured image may be transmitted to the consumer computing device 300 or stored at the real property analyzer 200 for further processing.

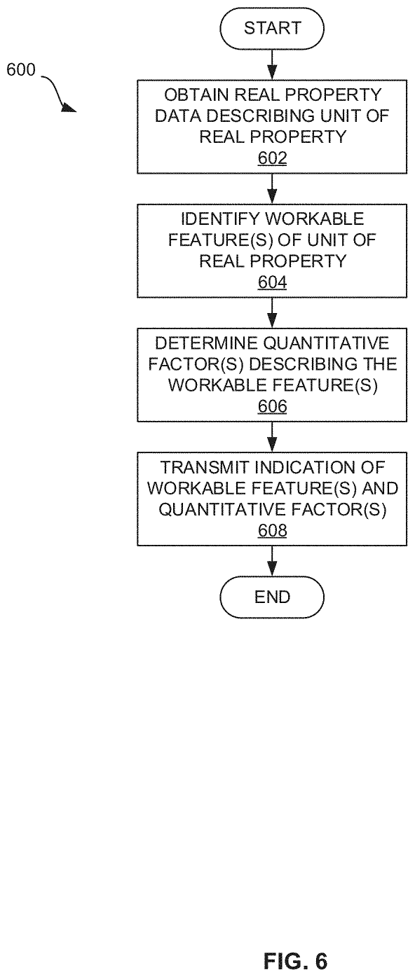

FIG. 6 is a flowchart of an example method 600 for preparing a unit of real property for the automated generation of a scope of work for working the unit of real property. One or more of the blocks of the method 600 may be embodied in instructions stored on a non-transitory machine-readable storage medium executable by one or more processors of a computing device. Such a computing device may include the real property analyzer 200 of FIG. 1, and for convenience the method 600 is described as being executed by the real property analyzer 200 of FIG. 1, but this is not limiting, and the method 600 may be performed by other systems and/or devices.

At block 602, the real property analyzer 200 obtains real property data describing the unit of real property 104. At block 604, the real property analyzer 200 identifies a workable feature of the unit of real property 104 based on the real property data. At block 606, the real property analyzer 200 determines a quantitative factor describing the workable feature. At block 608, the real property analyzer 200 transmits an indication of the workable feature and the quantitative factor to the consumer computing device 300. In some examples, the method 600 may be modified or extended in any of the respects described herein with respect to the real property analyzer 200.

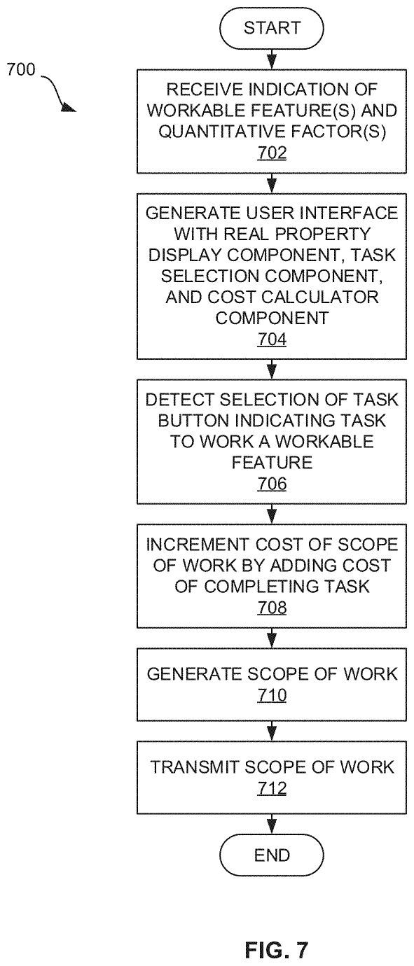

FIG. 7 is a flowchart of an example method 700 for generating a scope of work for working a unit of real property. One or more blocks of the method 700 may be embodied in instructions stored on a non-transitory machine-readable storage medium executable by one or more processors of a computing device. Such a computing device may include the consumer computing device 300 of FIG. 1, and for convenience the method 700 is described as being executed by the consumer computing device 300 of FIG. 1, but this is not limiting, and the method 700 may be performed by other systems and/or devices.

At block 702, the consumer computing device 300 receives an indication of a workable feature of the unit of real property 104 and a quantitative factor associated with the workable feature. At block 704, the consumer computing device 300 generates a user interface having a real property display component 322, the real property display component 322 including a visual display of the unit of real property 104 and the workable feature, a task selection component 324 including a task button 325 indicating a particular task to work the workable feature, and a cost calculator component 326 to display a cost to complete a scope of work involving one or more tasks to be performed on workable features of the unit of real property 104. At block 706, the consumer computing device 300 detects selection of the task button. At block 708, the consumer computing device 300 increments the cost of completing the scope of work by a cost of performing the particular task to work the workable feature. At block 710, the consumer computing device 300 generates a scope of work indicating one or more particular tasks to be performed on one or more workable features of the unit of real property 104. At block 712, the consumer computing device 300 transmits the generated scope of work to the provider computing device 400. In some examples, the method 700 may be modified or extended in any of the respects described herein with respect to the consumer computing device 300.

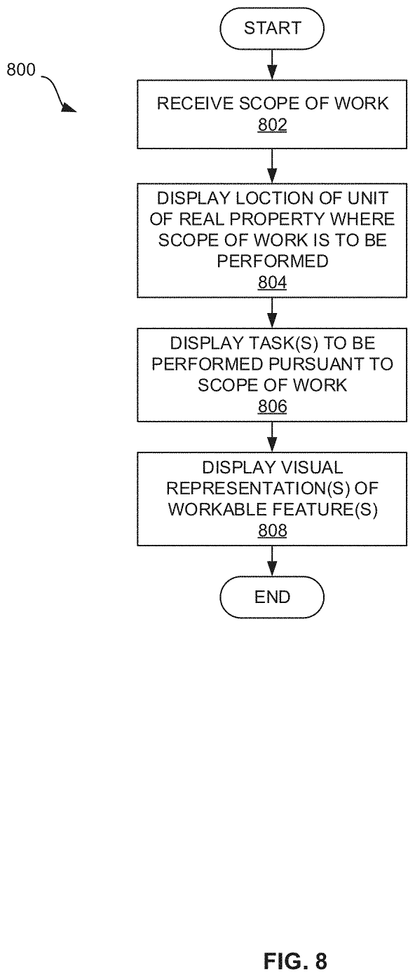

FIG. 8 is a flowchart of an example method 800 for displaying a scope of work for working real property. One or more blocks of the method 800 may be embodied in instructions stored on a non-transitory machine-readable storage medium executable by one or more processors of a computing device. Such a computing device may include the provider computing device 400 of FIG. 1, and for convenience the method 800 is described as being executed by the provider computing device 400 of FIG. 1, but this is not limiting, and the method 800 may be performed by other systems and/or devices.

At block 802, the provider computing device 400 receives as scope of work indicating one or more tasks to be performed on one or more workable features of the unit of real property. At block 804, the provider computing device 400 displays through the provider user interface 420 a map component 422 which displays a map indicating a location of the unit of real property 104 where a scope of work is to be performed. At block 806, the provider computing device 400 displays through the provider user interface 420 a task display component 424 listing one or more tasks to be completed pursuant to the scope of work. At block 808, the provider computing device 400 displays through the provider user interface 420 a real property display component 426 which displays visual representations of the workable features of the unit of real property 104 on which the tasks are to be performed. In some examples, the method 800 may be modified or extended in any of the respects described herein with respect to the provider computing device 400.

Thus, it can be seen that a consumer of goods or services relating to real property may generate a scope-of-work request for a provider based on the automated analysis of workable features of the unit of real property as informed by quantitative factors determined by a real property analyzer. The scope-of-work may be generated through a customer user interface by selecting tasks to work workable features of the property. The workable features of the property may have been identified by an automated system based on real estate data. Once a scope-of-work request is generated, the provider of goods or services may receive the scope-of-work request and refer to the scope-of-work request when fulfilling the scope-of-work. Transaction costs associated with the provider visiting the real property may thereby be attenuated.

The scope of the invention should not be limited by the above examples but should be given the broadest interpretation consistent with the description as a whole.

What may be claimed is:

1. A non-transitory machine-readable storage medium comprising instructions that when executed cause a processor of a computing device to:
obtain real property data describing a unit of real property;
identify a workable feature of the unit of real property based on the real property data;
determine a quantitative factor describing the workable feature; and
provide an indication of the workable feature and the quantitative factor to another computer device.

2. The non-transitory machine-readable storage medium of claim 1, wherein the quantitative factor of the workable feature of the unit of real property includes a physical dimension of the workable feature.

3. A non-transitory machine-readable storage medium comprising instructions that when executed cause a processor of a computing device to:
receive an indication of a workable feature of a unit of real property and a quantitative factor describing the workable feature;
generate a user interface including:
a real property display component including a visual representation of the unit of real property and a visual representation of the workable feature,
a task selection component including a task button indicating a particular task to work the workable feature, and
a cost calculator component to display a cost to complete a scope of work involving one or more tasks to be performed on one or more workable features of the unit of real property; and
upon detecting selection of the task button, increment the cost of completing the scope of work by a cost of performing the particular task to work the workable feature.

4. The non-transitory machine-readable storage medium of claim 3, wherein the task selection component includes a plurality of task buttons each associated with a respective task to work a different workable feature of the unit of real property, and wherein the instructions to cause the processor to, upon selection of a particular task button of the plurality of task buttons, increment the cost of completing the scope of work by a cost of performing the respective task.

5. The non-transitory machine-readable storage medium of claim 3, wherein the quantitative factor of the workable feature of the unit of real property includes a physical dimension of the workable feature.

6. The non-transitory machine-readable storage medium of claim 3, wherein the visual representation of the workable feature is embedded in the visual representation of the unit of real property.

7. The non-transitory machine-readable storage medium of claim 3, wherein the real property display component includes a visual representation of lighting on the unit of real property.

8. The non-transitory machine-readable storage medium of claim 3, wherein the task selection component includes an indication of a quantitative factor describing the task, the indication displayed visually associated with the task button.

9. The non-transitory machine-readable storage medium of claim 3, wherein the real property display component includes a task button for the selection of a workable feature overlain over the visual representation of the workable feature.

10. The non-transitory machine-readable storage medium of claim 3, wherein, upon detecting selection of the task button, the instructions cause the processor of the computing device to highlight the visual representation of the workable feature.

11. The non-transitory machine-readable storage medium of claim 3, further comprising instructions that when executed cause the processor of the computing device to:
generate a scope of work indicating one or more particular tasks to be performed on one or more workable features of the unit of real property; and
transmit the generated scope of work to another computing device.

12. A system for generating a scope of work for working real property, the system comprising:
a real property analyzer to obtain real property data describing a unit of real property, identify a workable feature of the unit of real property based on the real property data, and determine a quantitative factor describing the workable feature;
a consumer computing device to receive an indication of the workable feature of the unit of real property and the quantitative factor describing the workable feature, and generate a scope of work to perform one or more tasks on one or more workable features of the unit of real property; and
a provider computing device to receive the scope of work, display a location of the unit of real property where the scope of work is to be performed, display a list of one or more tasks to be completed pursuant to the scope of work, and display visual representations of one or more workable features of the unit of real property on which the one or more tasks are to be performed.

13. The system of claim 12, wherein the quantitative factor of the workable feature of the unit of real property includes a physical dimension of the workable feature.

14. The system of claim 12, wherein the real property analyzer is to obtain the real property data from an external resource, the real property data comprising one or more of: real estate data describing the unit of real property, land title registry data describing the unit of real property, physical dimensions of a parcel of land of the unit of real property, and aerial imagery data of the unit of real property.
